(19) United States
(12) Patent Application Publication
(10) Pub. No.: US 2012/0273681 A1
(43) Pub. Date: Nov. 1, 2012

(54) TERAHERTZ SPECTROMETER

(75) Inventors: Brian Jason Schulkin, Longmeadow, MA (US); Thomas David Tongue, Niskayuna, NY (US); Justin Graf St. James, Troy, NY (US)

(73) Assignee: Zomega Terahertz Corporation, East Greenbush, NY (US)

(21) Appl. No.: 13/455,590

(22) Filed: Apr. 25, 2012

Related U.S. Application Data
(60) Provisional application No. 61/479,165, filed on Apr. 26, 2011.

(51) Int. Cl. G01J 3/28

(52) U.S. Cl. 250/339.06

(57) ABSTRACT

A solution for analyzing characteristics of compounds and materials (e.g., chemical composition, specific quantity, thickness, etc.) via THz time domain spectrometry is disclosed. In one embodiment, a spectrometry system includes: a portable housing including: a portable power source; a laser source connected to the portable power source; a terahertz (THz) emitter located within the portable housing and optically connected to the laser source via an optical array including a rotary delay stage, the THz emitter configured to emit THz radiation directed to interact with a material sample; a detector optically connected to the optical array and configured to obtain waveform data from the interaction between the THz radiation and the material sample; and a computing device communicatively connected to the detector and configured to process the waveform data to determine a characteristic of the material sample.

### CROSS REFERENCE TO RELATED APPLICATION

This patent application claims the benefit of co-pending U.S. Provisional Patent Application Ser. No. 61479165, filed Apr. 25, 2011, which is hereby incorporated by reference.

### BACKGROUND OF THE INVENTION

The subject matter disclosed herein relates to terahertz (THz) spectrometer systems and, more particularly, to THz spectrometer systems for analyzing material samples (e.g., determining chemical composition, specific quantity, thickness, etc.) which can be made portable.

In some fields, accurately identifying and determining chemical compositions and compounds (e.g., explosives, narcotics, etc.) may be an important, time sensitive task. Technicians may require identification of a substance before proceeding with a given operation. Analysis of materials may be performed by a THz spectrometer which exposes a substance sample to a THz radiation pulse and processes the resultant waveforms to identify characteristics of the substance (e.g., chemical composition, specific quantity, thickness, etc.). To date, THz spectrometers typically have large dimensions and/or are too cumbersome to be brought to the sample, requiring installation and operation in a laboratory facility in order to properly operate. This requires technicians to obtain test samples from the unknown compound and to then transport the test samples to the THz spectrometer for analysis.

### BRIEF DESCRIPTION OF THE INVENTION

The inventors recognize that transportation may greatly increase the delay in composition identification and these samples may be difficult to obtain, maintain, transport, and test in a manner that does not introduce errors in the result. Thus, these systems may be imprecise, time consuming, and/or inefficient.

A solution for analyzing characteristics of material samples is disclosed. In one embodiment, a spectrometry system includes: a portable housing including: a portable power source; a laser source connected to the portable power source; a terahertz (THz) emitter located within the portable housing and optically connected to the laser source via an optical array including a rotary delay stage, the THz emitter configured to emit THz radiation directed to interact with a material sample; a detector optically connected to the optical array and configured to obtain waveform data from the interaction between the THz radiation and the material sample; and a computing device communicatively connected to the detector and configured to process the waveform data to determine a characteristic of the material sample.

A first aspect of the invention provides a spectrometry system including: a portable housing including: a portable power source; a laser source connected to the portable power source; a terahertz (THz) emitter located within the portable housing and optically connected to the laser source via an optical array including a rotary delay stage, the THz emitter configured to emit THz radiation directed to interact with a material sample; a detector optically connected to the optical array and configured to obtain waveform data from the interaction between the THz radiation and the material sample; and a computing device communicatively connected to the detector and configured to process the waveform data to determine a characteristic of the material sample.

A second aspect of the invention provides a program product stored on a computer readable storage medium for determining a characteristic of a material sample, the computer readable storage medium comprising program code for causing a computer system to: obtain waveform data captured by a detector, the waveform data corresponding to an interaction between the material sample and a terahertz (THz) radiation beam and including a plurality of distinct sample waveforms; align the plurality of distinct sample waveforms relative one another; combine the aligned sample waveforms; process the combined and aligned sample waveforms to generate a set of spectrum data; and compare the set of spectrum data to a set of authenticated spectrum data to determine the characteristic of the material sample.

A third aspect of the invention provides a system including: at least one computing device configured to determine a characteristic of a material sample by performing a method including: obtaining waveform data captured by a detector, the waveform data corresponding to an interaction between the material sample and a terahertz (THz) radiation beam and including a plurality of distinct sample waveforms; aligning the plurality of distinct sample waveforms relative one another; combining the aligned sample waveforms; processing the combined and aligned sample waveforms to generate a set of spectrum data; and comparing the set of spectrum data to a set of authenticated spectrum data to determine the characteristic of the material sample.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a three-dimensional perspective view of a portion of a THz spectrometer according to an embodiment of the invention.

FIG. 2 shows a three-dimensional perspective view of a portion of a THz spectrometer according to an embodiment of the invention.

FIG. 3 shows a three-dimensional perspective exploded view of a portion of a THz spectrometer according to an embodiment of the invention.

FIG. 4 shows a schematic block diagram illustrating a portion of a THz spectrometer according to an embodiment of the invention.

FIG. 5 shows a schematic mechanical diagram illustrating a portion of a THz spectrometer according to an embodiment of the invention.

FIG. 6 shows a schematic mechanical diagram illustrating a portion of a THz spectrometer according to an embodiment of the invention.

FIG. 7 shows a three-dimensional perspective exploded view of a portion of a THz spectrometer according to an embodiment of the invention.

FIG. 8 shows a three-dimensional perspective exploded view of a portion of a THz spectrometer according to an embodiment of the invention.

FIG. 9 shows a schematic mechanical diagram illustrating a portion of a THz spectrometer according to an embodiment of the invention.

FIG. 10 shows a schematic illustration of an environment including a data system according to an embodiment of the invention.

FIG. 11 shows a graphical representation of a THz waveform according to an embodiment.

FIG. 12 shows a graphical representation of a THz waveform according to an embodiment.

FIG. 13 shows a graphical representation of a THz waveform according to an embodiment.

FIG. 14 shows a graphical representation of a set of THz waveforms according to an embodiment.

FIG. 15 shows a three-dimensional perspective view of a portion of a THz spectrometer according to an embodiment of the invention.

FIG. 16 shows a three-dimensional perspective of a portion of a THz spectrometer according to an embodiment of the invention.

FIG. 17 shows a three-dimensional perspective of a portion of a THz spectrometer according to an embodiment of the invention.

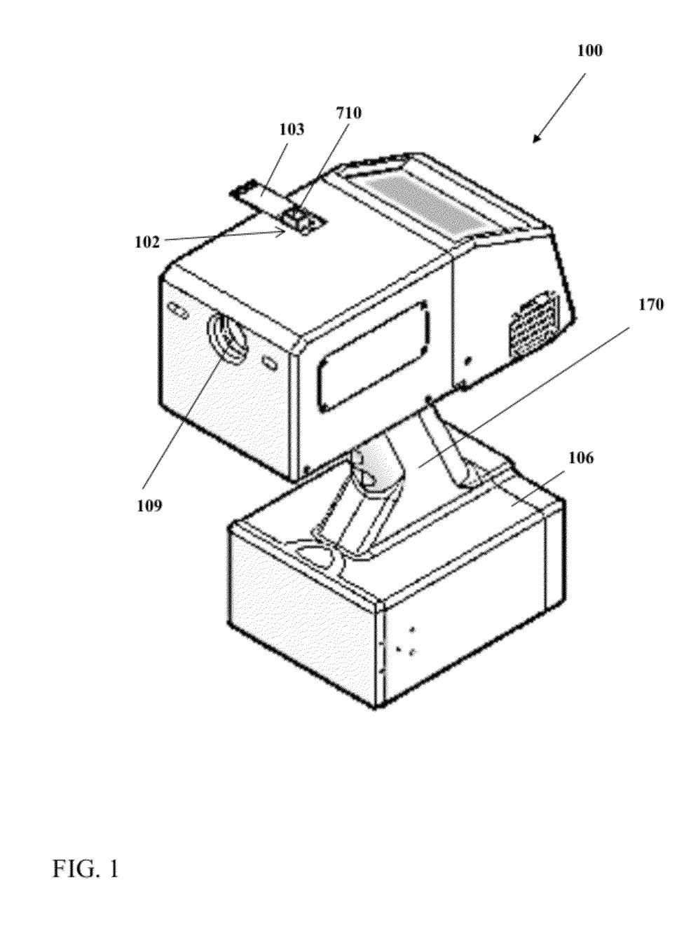

It is noted that the drawings of the disclosure are not necessarily to scale. The drawings are intended to depict only typical aspects of the disclosure, and therefore should not be considered as limiting the scope of the disclosure. It is understood that elements similarly numbered between the FIGURES may be substantially similar as described with reference to one another. Further, in embodiments shown and described with reference to FIGS. 1-17, like numbering may represent like elements. Redundant explanation of these elements has been omitted for clarity. Finally, it is understood that the components of FIGS. 1-17 and their accompanying descriptions may be applied to any embodiment described herein.

### DETAILED DESCRIPTION OF THE INVENTION

As indicated herein, aspects of the invention provide a solution for analyzing characteristics of compounds and materials (e.g., chemical composition, specific quantity, thickness, etc.) via THz time domain spectrometry which can be made portable and/or performed remotely. An illustrative system can include a portable housing including a compact laser and a delay system for creating a set of THz radiation pulses which are exposed to a material sample in order to generate a set of sample waveforms. These sample waveforms can be obtained by a detector which creates a set of waveform data values for the material sample, these waveform data values can be aligned, combined via a statistical method (e.g., an average, a weighted average, a mean, a sample distribution, a median, etc.), and analyzed by a computing device to determine a set of characteristics for the material. In contrast to conventional systems, an embodiment of the current invention can provide a portable THz system which remotely, accurately, and reliably analyzes material characteristics in the field. When activated, the system can emit an optimized THz radiation beam into an optic-path which directs the THz radiation beam to interact with the material sample and the detector. The THz beam can contact the material sample and reflect back a sample waveform which can be detected and processed by the computing device to determine a set of characteristics of the material sample. These characteristics can be displayed on a user interface for analysis and interpretation by a technician.

Turning to the FIGURES, embodiments of a system configured to analyze characteristics of compounds and materials by generating and managing a THz beam and analyzing an associated data set are disclosed. Each of the components in the FIGURES may be operatively and/or communicatively connected via hardwired, wireless, or other conventional means as is indicated in FIGS. 1-17. Specifically, referring to FIG. 1, an illustrative three-dimensional perspective view of a portion of a THz spectrometer 100 is shown according to an embodiment of the invention. THz spectrometer 100 may include a sample chamber 102 and a lens aperture 109 configured to enable scanning of material samples by THz spectrometer 100. Sample chamber 102 may include a cover 103 and may slidingly receive a vial 710 for analysis of a material sample. In one embodiment, during operation, a material sample may be placed in vial 710 and inserted into sample chamber 102 for exposure to a THz radiation beam and analysis by THz spectrometer 100 (as described herein). In another embodiment, a sample may be analyzed externally via THz lens aperture 109. During operation, a technician may position THz spectrometer 100 proximate a material sample and analyze the sample via a THz radiation beam emitted through THz lens aperture 109. THz spectrometer 100 may include a portable power source 106 which may be connected to THz spectrometer 100 and configured to power the components thereof. In one embodiment, portable power source 106 may be integrated into (e.g., internal) THz spectrometer 100. In another embodiment, portable power source 106 may be located external to THz spectrometer 100 (e.g., on a belt, in a backpack, etc.). It is understood that portable power source 106 may include a battery, a generator, or any other power source now known or later developed.

In an embodiment of the invention, THz spectrometer 100 may concurrently operate in both a reflection mode (e.g., THz lens aperture 109 analysis) and a transmission mode (e.g., sample chamber 102 analysis), passing a THz beam through sample chamber 102 and out through lens aperture 109. During operation, THz spectrometer 100 may automatically switch between modes based upon insertion and/or removal of vial 710 in sample chamber 102. Insertion of vial 710 in sample chamber 102 may unblock the THz beam and thereby enable the transmission mode while vial 710 is in sample chamber 102. Alternatively, when sample chamber 102 is empty, the THz beam may pass through lens aperture 109 for the reflection mode.

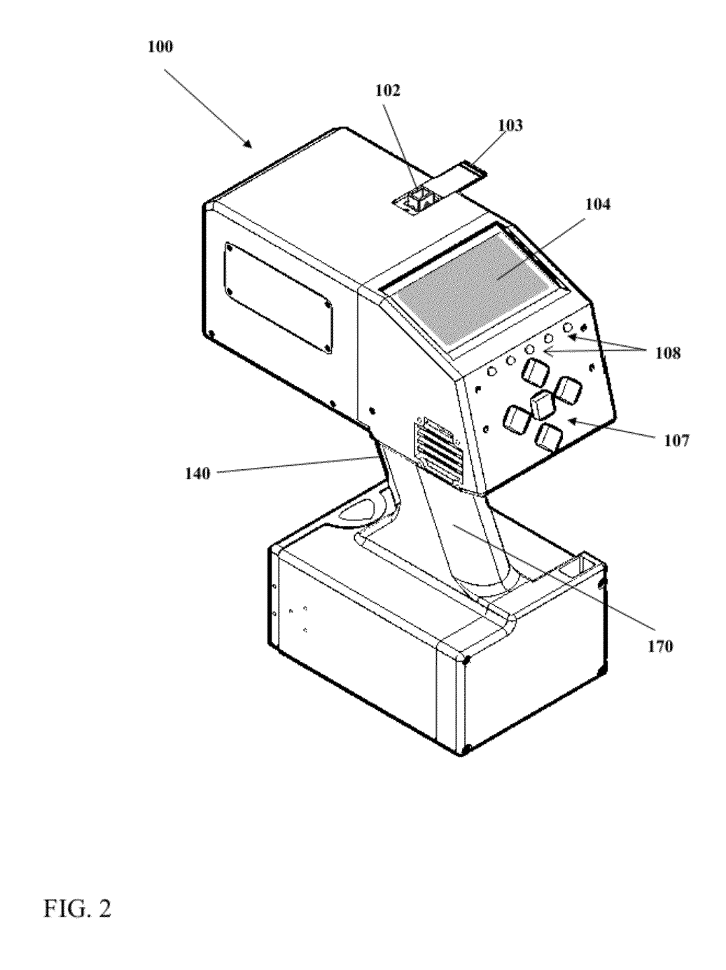

Turning to FIG. 2, an illustrative three-dimensional perspective view of a portion of THz spectrometer 100 is shown according to an embodiment of the invention. In this embodiment, THz spectrometer 100 includes a display 104 and user interface 107 configured to enable operation and adjustment of THz spectrometer 100. In one embodiment, THz spectrometer 100 may include an LED array 108 configured to visually communicate a status of THz spectrometer 100. LED array 108 may include a set of LEDs with varying colors configured to luminesce in response to a given condition or reading (e.g., warming up, ready to read, safe specimen, dangerous specimen, unable to identify specimen, etc.) of THz spectrometer 100. THz spectrometer 100 may include a handle 170 and an activation key 140 for manipulation and operation by a technician. It is understood that display 104 and user interface 107 are merely exemplary embodiments and that any form or combination of interface and/or display now known or later developed may be used, including but not limited to a liquid crystal display, a light-emitting diode (LED) display, a black and white display, an organic light-emitting diode, a touch-screen interface, etc.

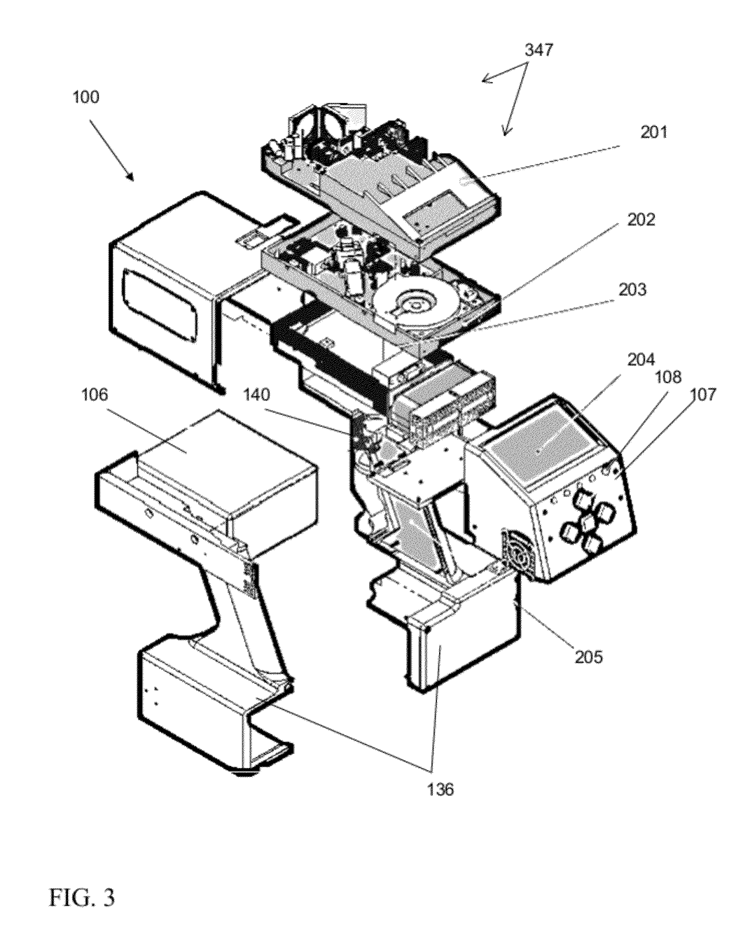

Turning to FIG. 3, a schematic three-dimensional perspective exploded view of a portion of THz spectrometer 100 is shown according to an embodiment. In this embodiment, THz spectrometer 100 includes a set of layers forming an optical array 347. The set of layers may be located within a portable housing 136 and include a THz management layer 201, an optical backplane layer 202 located beneath THz management layer 201, and an integrated laser layer 203 located beneath THz management layer 201 and optical backplane layer 202. It is understood that the orientation and arrangement of THz management layer 201, optical backplane layer 202, and integrated laser layer 203 relative one another are merely illustrative and that any combination or arrangement of the layers now known or later developed may be included.

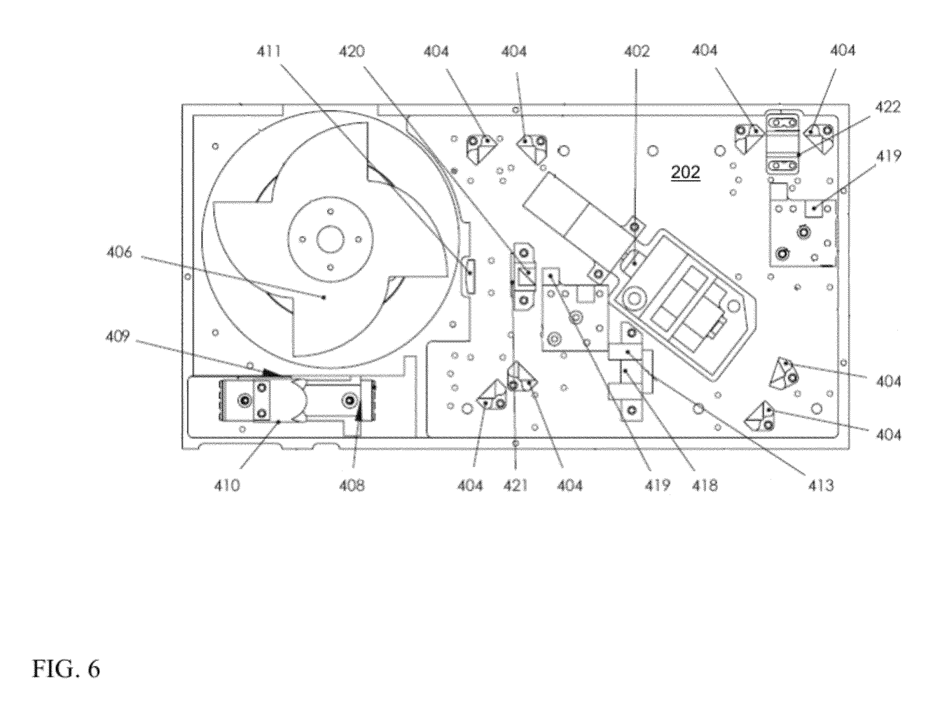

In an embodiment, integrated laser layer 203 may be internal to portable housing 136 and may include a laser source 402 (shown in FIG. 6) located within portable housing 136 and configured to operate THz spectrometer 100. In another embodiment, laser source 402 may be optically coupled to integrated laser layer 203 (e.g., an external source laser optically coupled to integrated laser layer 203). In one embodiment, laser source 402 may be located external to portable housing 136 (e.g., on a belt, in a backpack, etc.). THz spectrometer 100 may include a computing device 204 configured to process data (as discussed herein) for analysis of material samples. In one embodiment, THz spectrometer 100 may also include a power supply device 205 configured to manage power transmission from power source 106 (shown in FIG. 1) to integrated laser layer 203, computing device 204, and/or other components of THz spectrometer 100. In one embodiment, power source 106 may be located external to portable housing 136 (e.g., an external power source 106 electrically coupled to power supply device 205).

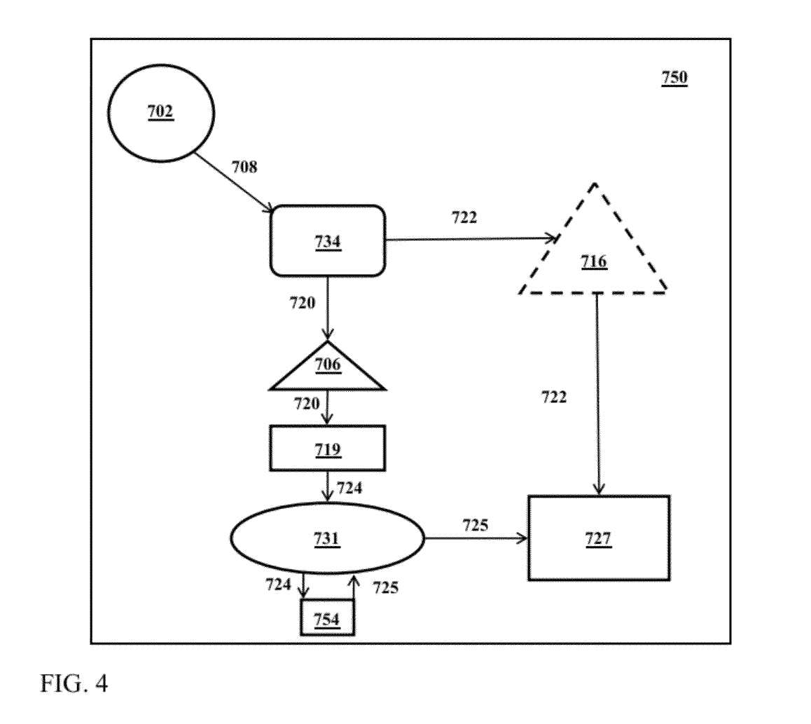

Turning to FIG. 4, a schematic block diagram illustrating operation of a portion of a THz spectrometer 750 is shown according to an embodiment. In this embodiment, a laser source 702 generates a laser pulse 708 which is directed to a beamsplitter 734 which is configured to split laser pulse 708 into a pump beam 720 and a probe beam 722. Pump beam 720 may be delayed by an optical delay device 706 which directs pump beam 720 to an emitter 719 (e.g., a photoconductive antenna) which may cause generation of a THz radiation beam 724 which passes into a set of optics 731. Set of optics 731 may direct THz radiation beam 724 to interact with a material sample 754, following interaction with material sample 754, a THz reaction beam 725 may pass back through set of optics 731 and to detector 727. In one embodiment, probe beam 722 may concurrently pass through THz spectrometer 750, optionally passing through a probe optical delay device 716 (shown in phantom) and arriving at detector 727 with THz reaction beam 725 for analysis.

In one embodiment, THz reaction beam 725 may meet with probe beam 722 at detector 727 simultaneously such that THz radiation for the sample may be detected and/or analyzed. In one embodiment, probe optical delay device 716 may retain probe beam 722 while pump beam 720 generates THz radiation beam 724 which contacts sample 754. Then, resultant THz reaction beam 725 may combine with probe beam 722 before detector 727 such that both THz reaction beam 725 and probe beam 722 arrive collinearly at receiver 727. In one embodiment, both THz radiation beam 724 and probe beam 722 may remain uncollimated throughout THz spectrometer 750. In one embodiment, laser pulse 708 may be optimized for use in THz spectrometry by laser source 702 which may generate laser pulse 708 at wavelengths from about 700 nm to about 2 μm, and at a pulse repetition rate from about 1 MHz to about 2 GHz. In one embodiment, each sample waveform may be obtained at a frequency of greater than about 100 hertz.

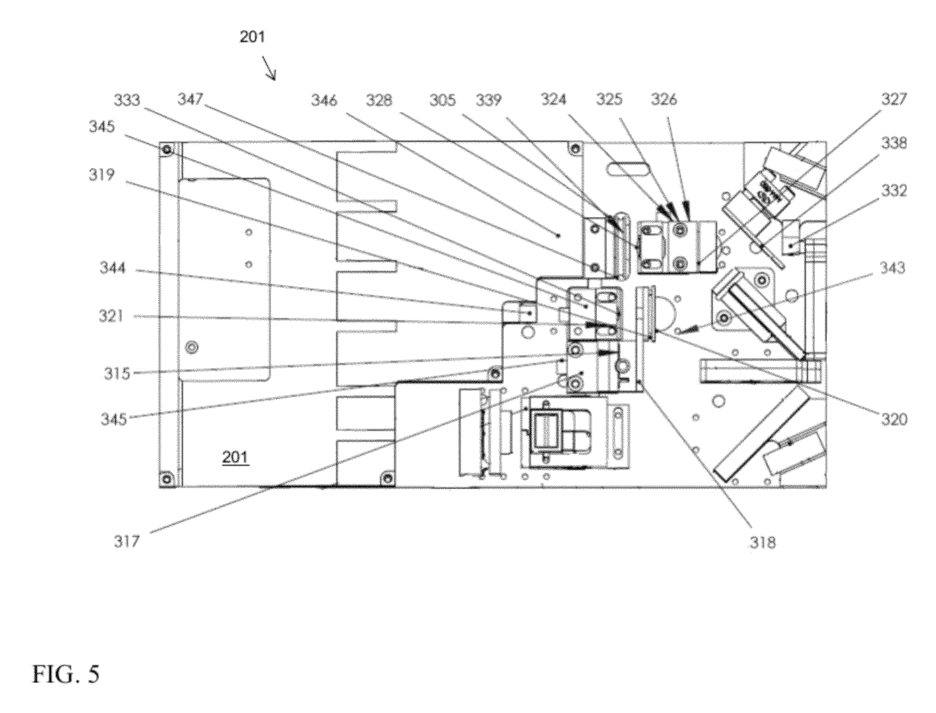

Turning to FIG. 5, a schematic mechanical diagram illustrating a portion of THz spectrometer 100 is shown according to an embodiment. In this embodiment, an emitter 319 on THz management layer 201 includes a photoconductive antenna (PCA) attached to a lens 320 for THz coupling. In one embodiment, lens 320 may include a hemisphere lens. Lens 320 may include silicon or other materials as are known and may have any shape and/or focal length as are known or later developed. During operation, a laser pulse generated by laser source 402 (shown in FIG. 6) may be optically connect to/contact emitter 319, generating a THz radiation beam which may traverse THz management layer 201, contacting/interacting with a material sample and then being sampled by a detector 327 for analysis by computing device 204 (shown in FIG. 3). In one embodiment, detector 327 may include at least one of an electro-optic (EO) detector (e.g., ZnTe) attached to a lens (e.g., a crystal quartz lens, a high resistivity silicon lens or other lens materials as are known) and a photoconductive antenna.

Turning to FIG. 6, a schematic mechanical diagram illustrating a portion of THz spectrometer 100 is shown according to an embodiment. In this embodiment, laser source 402 may emit a set of ultra-fast laser pulses (e.g., less than about 200 fs) which may have a central wavelength of about 700 nm to about 2000 nm. These ultra-fast laser pulses may be directed by a set of mirrors 404 through optical filter 413 and half-waveplate 418. The ultra-fast laser pulses may contact beamsplitter 420 and split into a pump beam and a probe beam. In one embodiment, the ratio of intensities between the pump beam and probe beam may be controlled by an angle of half-waveplate 418. In one embodiment, following contact with beamsplitter 420, the pump beam may pass through a waveplate 421 which rotates the pump beam before passing through a cylindrical lens 411. Cylindrical lens 411 may direct the pump beam to rotary delay 406 which may act as a high speed variable timing delay that allows THz spectrometer 100 to scan the THz waveform as a function of relative delay. The pump beam may reflect from rotary delay 406 back through cylindrical lens 411 and back through waveplate 421 which further rotates the pump beam such that the pump beam may pass through polarizing beam splitter 420. Once through polarizing beam splitter 420, the pump beam may pass to THz management layer 201 (shown in FIG. 3) from optical backplane 202 to emitter 319 for generation of the THz radiation beam which passes through THz optics 731 (shown in FIG. 4) to interact with the material sample. Following interaction with the material sample, the THz radiation beam may pass back through THz optics 731 and contact detector 327. In one embodiment, the probe beam may pass through a set of probe optics to arrive at the detector 327 substantially simultaneously with the THz radiation beam. In one embodiment, the probe beam may traverse a delay stage.

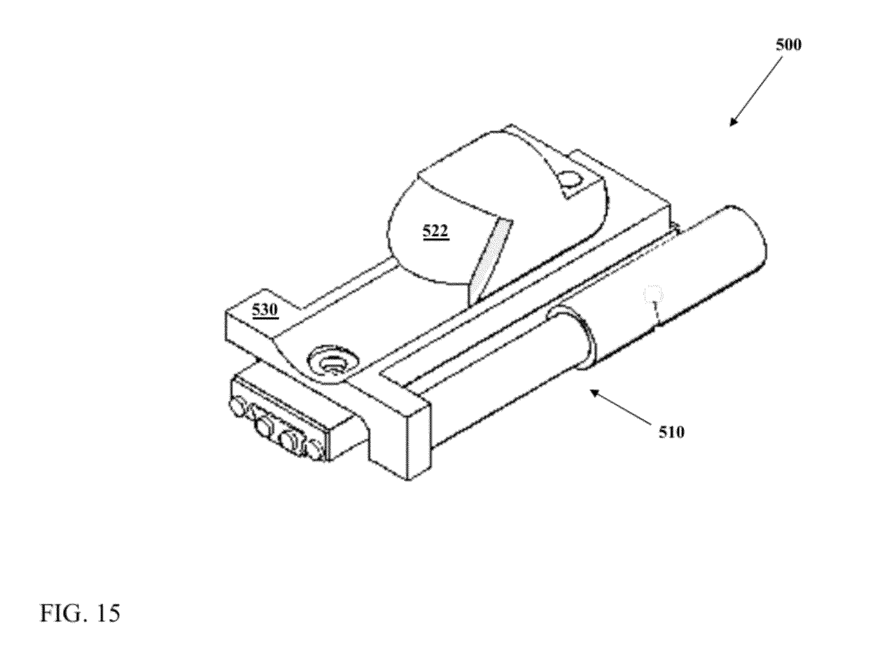

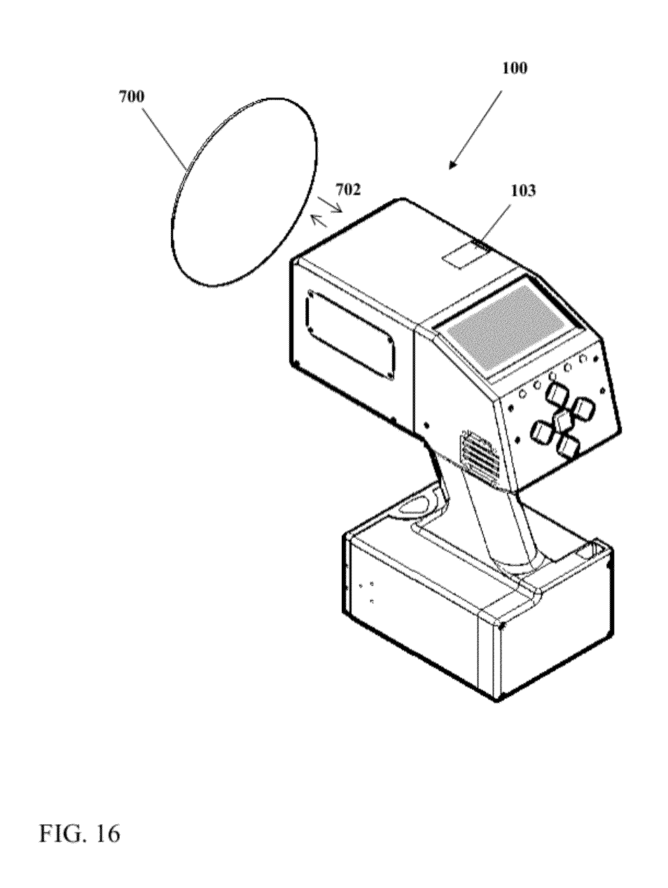

In one embodiment, the THz radiation beam may be sampled via a rotary optical delay device 406 on optical backplane layer 202. In one embodiment, optical delay device 406 may provide a linear optical delay with rotation angle. In one embodiment, the THz radiation beam may be sampled via a linear optical delay device 410 on optical backplane layer 202. Linear optical delay device 410 may provide a linear translation stage for translating a number of retro-reflectors (shown in FIG. 15) back and forth which forms a variable optical delay, which enables sample THz waveforms to be captured while the optical delay is scanned. Optical delay device 406 may have multiple rotation symmetries which make it possible to scan several waveforms in a single rotation. In one embodiment, optical delay device 406 may be spun for THz waveform acquisition rates up to about 1 kHz with an optical delay range of about 115 ps. It is understood that a shape and/or orientation of optical delay device 406 may include but is not limited to an involute mirror, a polygonal mirror, a flat mirror, a prism, or any other configuration or combination now known or later developed.

In one embodiment, optical backplane 202 includes a polarizing beam splitter 420 which interacts with the optical beam to form the pump beam and probe beam. The probe beam may pass through beam splitter 420 and reflects off set of mirrors 404 before reflecting off linear optical delay device 410 (e.g., a retroreflector) mounted on a linear stage 408 that is actuated by a fine linear screw 409. In one embodiment, the probe beam may be reflected off set of mirrors 404 through an adjustable focusing lens 422 to another mirror 404 and up to THz layer 201 by a flexure mounted mirror 419. In one embodiment, the probe beam may be directed through an Indium Tin Oxide (ITO) plate 338 (shown in FIG. 5) by a mirror 332 (shown in FIG. 5) in order to be collinear with the THz beam.

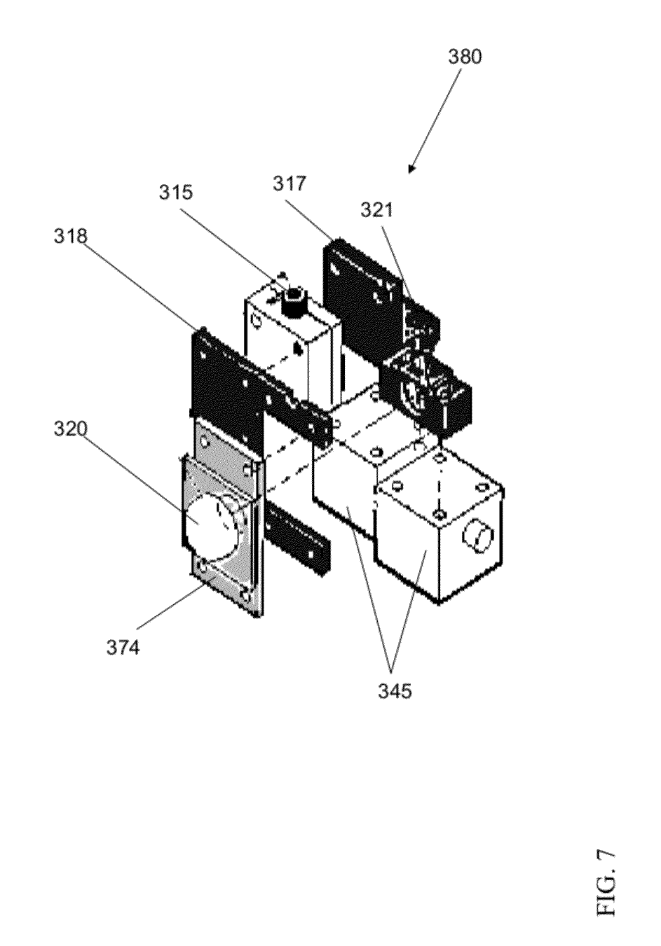

Turning to FIG. 7, a schematic three-dimensional perspective exploded view of a portion of THz spectrometer 100 is shown according to an embodiment. In this embodiment, a THz emitter assembly 380 (e.g., an X-Y-Z translation stage assembly) hosts THz emitter 319 (shown in FIG. 5). The pump beam may be directed via mirror 344 (shown in FIG. 5), which steers the pump beam through a lens 333 (shown in FIG. 5) in a lens mount 321 on a X-Y translation stage 345. The pump beam may be focused on THz emitter 319 (e.g., a photoconductive antenna) with a pre-aligned hyper-hemisphere lens 320 mounted on an antenna dock (e.g., (printed circuit board (PCB)) 374 that is held in place by THz emitter assembly 380. THz emitter assembly 380 may include a stage 315, an antenna adapter 317, an antenna mount 318, and antenna dock 374. The alignment of the pump beam may be controlled by the insertion of an alignment probe (e.g., a rigid mounted quad-detector) at high-precision mounting holes 343 (shown in FIG. 5).

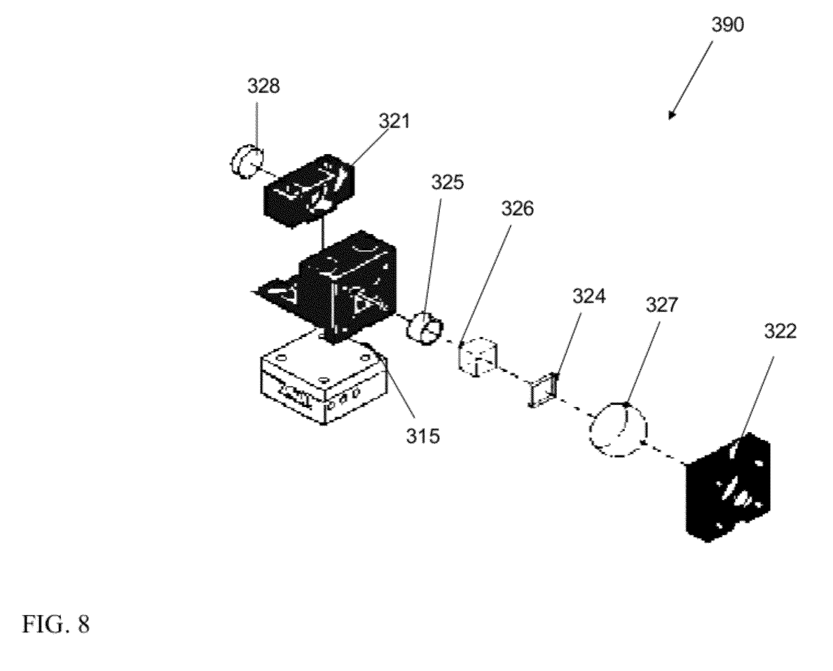

Turning to FIG. 8, a schematic three-dimensional perspective exploded view of a portion of THz spectrometer 100 is shown according to an embodiment. In this embodiment, a detection unit 390 is shown including a lens 327 which focuses at least one of the THz beam and the probe beam into an electro-optic (EO) crystal 324. In one embodiment, lens 327 may be fabricated as a hyperhemisphere from crystal quartz. In another embodiment, lens 327 may be fabricated from at least one of high resistivity silicon and rutile. It is understood that these examples of lens 327 are merely illustrative, and that lens 327 may be fabricated from any material now known or later developed. EO crystal 324 may include ZnTe, GaAs, GaP, CdTe, GaSe or any other material used for EO sampling. EO crystal 324 may be pressed against a spring 325 and a set of optical materials 326 in order to delay or reduce reflections in quartz lens 327. A mount 322 may retain and/or position portions of detection unit 390. In one embodiment, the probe beam may pass through EO crystal 324 and set of optical materials 326 and be focused by a lens 328 through a quarter wave plate 339 (shown in FIG. 5) mounted on a pulley 307 (shown in FIG. 5) which is used to balance the S- and P-polarizations of the probe beam. The probe beam may pass from quarter wave plate 339 through a prism 346 (e.g., a Wollaston prism)(shown in FIG. 5), to a pair of photodiodes 347 which measure the S- and P-polarization of the probe beam in a balanced detector configuration. This signal may then be sampled and processed by computing device 204 (e.g., which can include a digital signal processor (DSP)). It is understood that THz radiation generation may include the use of photoconductive antennae, surface emitters, optical rectification with EO crystals, etc. Furthermore, it is understood that detection may include the use of EO detection, photoconductive antennas, poled polymers, etc.

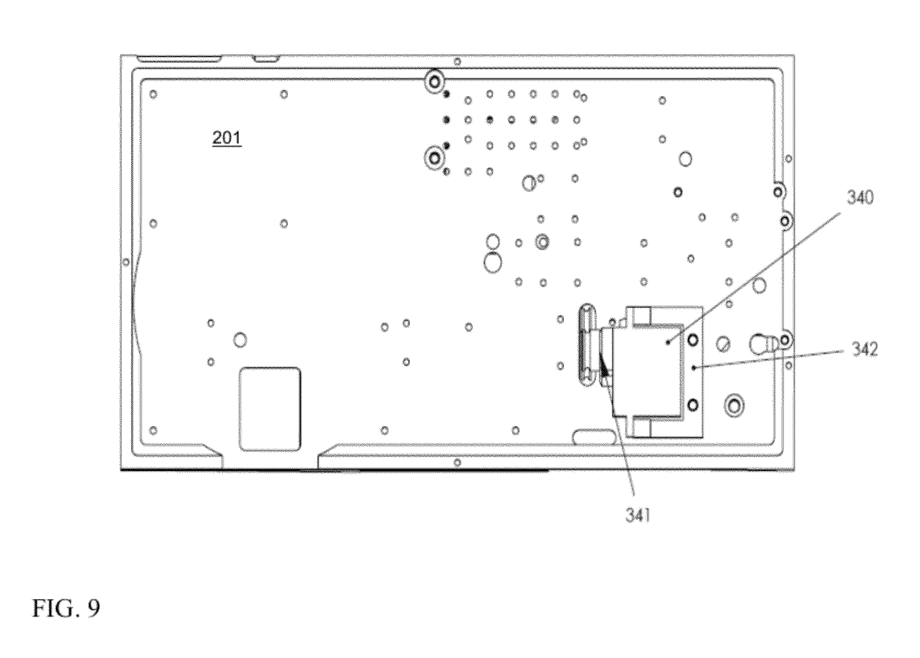

Turning to FIG. 9, a schematic block diagram illustrating a portion of a THz spectrometer is shown according to an embodiment. In this embodiment, THz management layer 201 includes a servo 340, a servo pulley 341 and an autobalance servo mount 342 operatively connected to a pulley 305 (shown in FIG. 5) hosting optical quarter-waveplate 339 (shown in FIG. 5). Servo 340, servo pulley 341, and autobalance servo mount 342 may adjust a position of optical quarter-waveplate 339 (shown in FIG. 5) and/or components therein. In one embodiment, a technician may manually manipulate components of optical quarter-waveplate 339 via user interface 104 and servo 340. In another embodiment, manipulation of components of optical quarter-waveplate 339 may be performed automatically by THz spectrometer 100 and/or computing device 204.

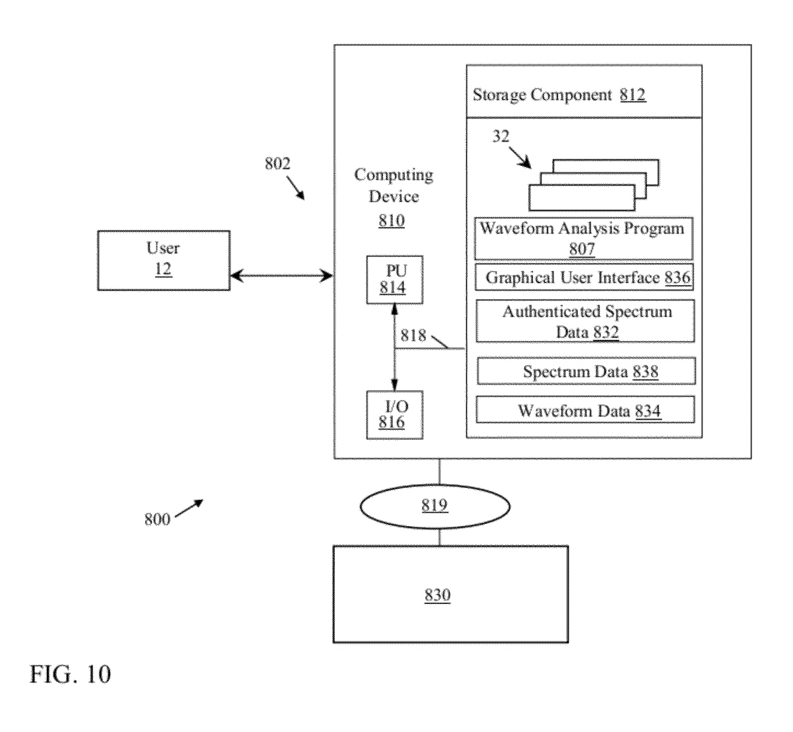

Turning to FIG. 10, a schematic illustration of an environment 800 including a waveform analysis system 802 in accordance with an embodiment of the invention is shown. Environment 800 includes a computing device 810 that can perform the various processes described herein. In particular, computing device 810 includes waveform analysis program 807, which enables computing device 810 to analyze a specimen/material sample by performing a process described herein. In one embodiment, computing device 810 may determine a characteristic, composition, and/or identity of the material sample based on a set of THz waveforms obtained from the material sample during operation. The waveform analysis program 807 may include THz waveform routines to enable calculation, alignment, combining (e.g., averaging), Fourier Transforms (FT), spectral analysis, and/or comparison and correlation of spectral responses.

As previously mentioned and discussed further below, waveform analysis program 807 has the technical effect of enabling computing device 810 to perform, among other things, the analysis described herein. It is understood that some of the various components shown in FIG. 10 can be implemented independently, combined, and/or stored in memory for one or more separate computing devices that are included in waveform analysis system 802. Further, it is understood that some of the components and/or functionality may not be implemented, or additional schemas and/or functionality may be included as part of waveform analysis system 802.

Waveform analysis system 802 is shown including a processing (PU) component 814 (e.g., one or more processors), a storage component 812 (e.g., a storage hierarchy), an input/output (I/O) component 816 (e.g., one or more I/O interfaces and/or devices), and a communications pathway 818. In general, processing component 814 executes program code, such as waveform analysis program 807, which is at least partially fixed in storage component 812. While executing program code, processing component 814 can process data, which can result in reading and/or writing transformed data from/to storage component 812 and/or I/O component 816 for further processing. Pathway 818 provides a communications link between each of the components in waveform analysis system 802. I/O component 816 can comprise one or more human I/O devices, which enable a human user/technician 12 to interact with waveform analysis system 802 and/or one or more communications devices to enable a system user 12 to communicate with waveform analysis system 802 using any type of communications link. To this extent, waveform analysis program 807 can manage a set of interfaces (e.g., graphical user interface(s), application program interface, and/or the like) that enable human and/or system users 12 to interact with waveform analysis program 807. Further, waveform analysis program 807 can manage (e.g., store, retrieve, create, manipulate, organize, present, etc.) the data, such as waveform data 834, spectrum data 838, and/or authenticated spectrum data 832, using any solution.

In any event, waveform analysis system 802 can comprise one or more general purpose computing articles of manufacture (e.g., computing devices) capable of executing program code, such as waveform analysis program 807, installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. To this extent, waveform analysis program 807 can be embodied as any combination of system software and/or application software.

Further, waveform analysis program 807 can be implemented using a set of modules 32. In this case, a module 32 can enable waveform analysis system 802 to perform a set of tasks used by waveform analysis program 807, and can be separately developed and/or implemented apart from other portions of waveform analysis program 807. As used herein, the term “component” means any configuration of hardware, with or without software, which implements the functionality described in conjunction therewith using any solution, while the term “module” means program code that enables a waveform analysis system 802 to implement the actions described in conjunction therewith using any solution. When fixed in a storage component 812 of a waveform analysis system 802 that includes a processing component 814, a module is a substantial portion of a component that implements the actions. Regardless, it is understood that two or more components, modules, and/or systems may share some/all of their respective hardware and/or software. Further, it is understood that some of the functionality discussed herein may not be implemented or additional functionality may be included as part of waveform analysis system 802.

When waveform analysis system 802 comprises multiple computing devices, each computing device can have only a portion of waveform analysis program 807 fixed thereon (e.g., one or more modules 32). However, it is understood that waveform analysis system 802 and waveform analysis program 807 are only representative of various possible equivalent computer systems that may perform a process described herein. To this extent, in other embodiments, the functionality provided by waveform analysis system 802 and waveform analysis program 807 can be at least partially implemented by one or more computing devices that include any combination of general and/or specific purpose hardware with or without program code. In each embodiment, the hardware and program code, if included, can be created using standard engineering and programming techniques, respectively.

Regardless, when waveform analysis system 802 includes multiple computing devices, the computing devices can communicate over any type of communications link. Further, while performing a process described herein, waveform analysis system 802 can communicate with one or more other computer systems using any type of communications link. In either case, the communications link can comprise any combination of various types of optical fiber, wired, and/or wireless links; comprise any combination of one or more types of networks; and/or utilize any combination of various types of transmission techniques and protocols.

In some embodiments, as shown in FIG. 10, environment 800 may include a detector 819 adapted to measure the THz radiation that has interacted with a specimen/material sample 830 and generate a set of waveform data 834 based thereon. In some embodiments, computing device 810 and waveform analysis program 807 may be located upon or within THz spectrometer 100. During operation, waveform analysis program 807 may process waveform data 834 to generate a set of spectrum data 838 (e.g., a frequency domain of the waveform) for comparison and/or correlation with a set of authenticated spectrum data 832 (e.g., a waveform spectrum that has been previously certified, a library of waveform spectrums, etc.). In one embodiment, set of spectrum data 838 may be generated by aligning a set of distinct waveforms in waveform data 834, combining (e.g., taking an average, taking a weighted average, taking a mean, taking a sample distribution, taking a median, etc.) the aligned waveforms via a statistical method, and processing the aligned waveforms to generate a spectrum. Spectrum data 838 may be displayed on a graphical user interface 836 via computing device 810 for review by technicians. In one embodiment, spectrum data 838 may be displayed in real-time on user interface 836.

In any event, computing device 810 can comprise any general purpose computing article of manufacture capable of executing computer program code installed by a user (e.g., a personal computer, server, handheld device, etc.). However, it is understood that computing device 810 is only representative of various possible equivalent computing devices and/or technicians that may perform the various process steps of the disclosure. To this extent, in other embodiments, computing device 810 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. In one embodiment, computing device 810 may integral to a spectrometer. In another embodiment, computing device 810 may be external to a spectrometer. In another embodiment, computing device 810 may be remote relative a spectrometer.

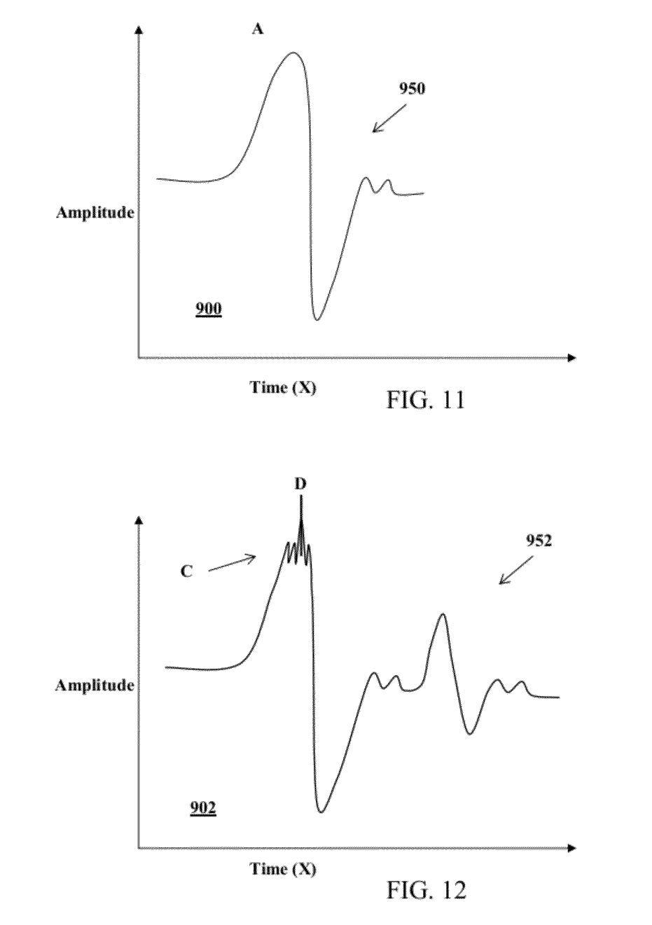

FIG. 11 illustrates a two-dimensional graphical representation 900 of a combined (e.g., averaged) THz waveform 950 plotted with time on the x-axis and waveform amplitude on the y-axis according to an embodiment of the invention. During operation, detector 109 (shown in FIG. 1) of THz spectrometer 100 may obtain a set of THz radiation reflections representing waveform data 834 over a period of time (e.g., a time constant (TC)). Computing device 810 may process waveform data 834 via a statistical function to develop a combined (e.g., averaged) THz waveform 950 for the TC. Combined THz waveform 950 may be used for further analysis by waveform analysis program 807 as discussed herein. In one embodiment, a sample/live THz waveform 952 (shown in FIG. 12) may be generated and evaluated for each sample a plurality of times over a given TC. Each distinct THz waveform 952 obtained during the TC may be stored in a distribution for the TC which may be combined and/or aligned as part of analysis by waveform analysis program 807.

Waveform analysis program 807 may adaptively align each distinct THz waveform 952 over a given TC (e.g., as each THz waveform 952 is obtained by detector 727 it is aligned with the previous THz waveforms 952 obtained by detector 727 during the TC). In one embodiment of the invention, TC may be manually set by a technician (e.g., about 1 second, about 10 seconds, etc.) such that waveform analysis program 807 may align and/or combine obtained waveform values every TC. In another embodiment, waveform analysis program 807 may automatically adjust and/or manipulate TC based on obtained data (e.g., a variation/change in sample waveform characteristics, a variation/change in distance from sample, etc.). Waveform analysis program 807 may remove all previous data and/or averaging and develop a new distribution in response to an adjusted TC. In one embodiment, waveform analysis program 807 may develop a histogram and/or confidence level based on stored data and/or sample results (e.g., confidence level of X % that the sample is Y; over TC, the sample was tested Q times and R times it was S, U times it was Z and V times it was undetermined) which are displayed on user interface(s) 104 and/or 836.

Turning to FIG. 12, a two-dimensional graphical representation 902 of sample THz waveform 952 is shown according to an embodiment of the invention. In this FIGURE, a waveform peak ‘C’ of THz waveform 952 includes a set of individual peaks. In one embodiment, shown in FIG. 12, to align a set of sample waveforms 952 obtained during a given period TC, waveform analysis program 807 may determine a value of a highest peak ‘D’ on each distinct sample waveform 952 obtained during TC and may align highest peak D of each sample waveform 952 with one another and/or a given point (e.g., a center of graphical representation 902, a center of user interface 836, etc) in graphical representation 902.

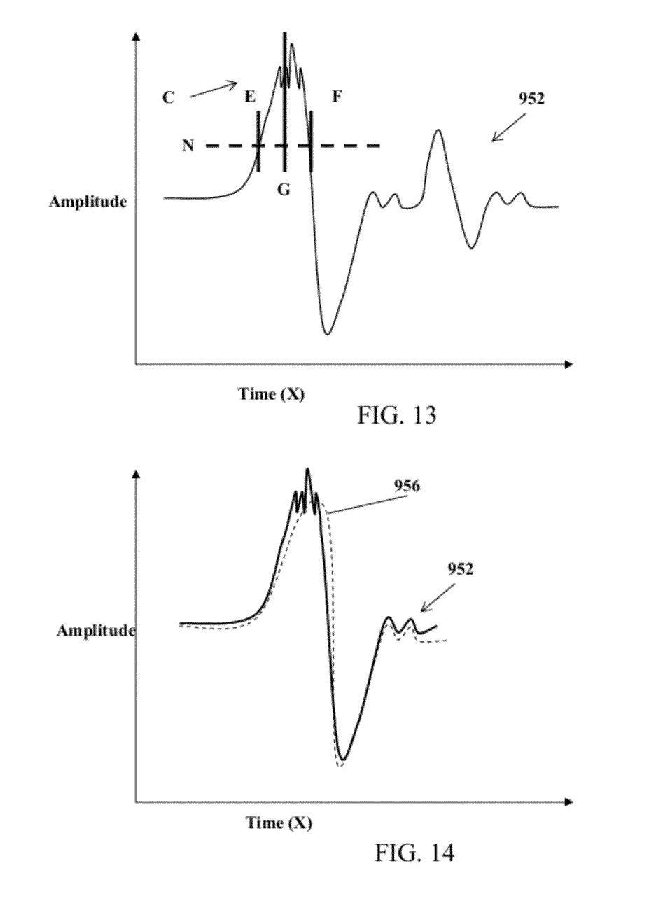

In another embodiment, shown in FIG. 13, a threshold level ‘N’ may be established relative a magnitude of sample THz waveform 952. During operation, a first crossing ‘E’ of THz waveform 952 above threshold level N and a second crossing ‘F’ of THz waveform 952 below threshold level N are recorded as are the magnitude of the amplitude values between crossings E and F. These values are then combined (e.g., averaged) to determine a centroid value ‘G’ for each distinct sample THz waveform 952 which may be used in alignment and/or combining with other distinct sample THz waveforms 952 obtained during a given period TC. Threshold level N may be manually set by a technician or automatically set by waveform analysis program 807. A position of threshold level N relative amplitude Y may be set to reduce noise (e.g., above the main pulse and secondary pulses) and capture a majority of peak values (e.g., capture a wide portion of peak C). Sample THz waveform 952 and/or combined waveform 950 may be displayed on user interface(s) 104 and 836 for analysis by a technician.

Turning to FIG. 14, in another embodiment, waveform analysis program 807 may align and/or combine set of sample waveforms 952 via a correlation method wherein each sample THz waveform 952 is matched with an ideal pulse THz waveform 956 (shown in phantom) by finding a minimum intersection via a cross-correlation method which has a minimum value and/or a maximum value. Correlation of sample waveforms 952 with ideal pulse THz waveform 956 may indicate positional and/or alignment information for each sample THz waveform 952 relative one another. Ideal pulse THz waveform 956 may include an entire waveform or a portion of a waveform and may be stored on computing device 810 from a database, previous testing/truthing of a known substance, etc. In one embodiment, this method may be performed via at least one of a hardware circuit and digital signal processing. In another embodiment, this method may be performed externally via a remote computer.

Following alignment, set of sample THz waveforms 952 may be combined (e.g., averaged) over TC to generate averaged THz waveform 950 (shown in FIG. 11). Waveform analysis program 807 may process combined THz waveform 950 to generate a set of spectrum data 838 (e.g., a frequency spectrum, a spectral response, spectral amplitude, etc.) based on aligned and combined sample THz waveforms 952. Waveform analysis program 807 may generate spectrum data 838 by calculating a Fourier transform (FT) of waveform data 834 and/or averaged THz waveform 950. In one embodiment, waveform analysis program 807 may generate spectrum data 838 by taking a discrete Fourier transform (DFT) of waveform data 834 and/or averaged THz waveform 950. In one embodiment, waveform analysis program 807 may generate spectrum data 838 by calculating a fast fourier transform (FFT) of waveform data 834 and/or combined THz waveform 950. Following generation of spectrum data 838, waveform analysis program 807 may compare spectrum data 838 with a spectral database and/or set of authenticated spectrum data 832 to identify characteristics of the material sample. Authenticated spectrum data 832 may be a set of known and/or verified spectral values for known materials which may be obtained from a database, from previous “truthing” analysis (e.g., THz spectrometer 100 analyzes a plurality of known substances to develop a certified spectral database), etc. During operation, waveform analysis program 807 may compare and/or correlate spectrum data 838 with authenticated spectrum data 832 to determine/identify like spectral responses and thereby a characteristic of the material sample.

In any event, computer system 802 can obtain any of waveform data 834, spectrum data 838, and/or authenticated spectrum data 832, using any solution. For example, computer system 802 can generate and/or be used to generate waveform data 834, spectrum data 838, authenticated spectrum data 832; retrieve waveform data 834, spectrum data 838, authenticated spectrum data 832, from one or more data stores; receive waveform data 834, spectrum data 838, authenticated spectrum data 832, from another system, and/or the like.

While shown and described herein as a solution for analyzing characteristics of material samples, it is understood that aspects of the invention further provide various alternative embodiments. For example, in one embodiment, the invention provides a computer program fixed in at least one computer-readable medium, which when executed, enables a computer system to analyze characteristics of material samples. To this extent, the computer-readable medium includes program code, such as waveform analysis program 807 (FIG. 10), which implements some or all of a process described herein. It is understood that the term “computer-readable medium” comprises one or more of any type of tangible medium of expression, now known or later developed, from which a copy of the program code can be perceived, reproduced, or otherwise communicated by a computing device. For example, the computer-readable medium can comprise: one or more portable storage articles of manufacture; one or more memory/storage components of a computing device; paper; and/or the like.

In another embodiment, the invention provides a method of providing a copy of program code, such as waveform analysis program 807 (FIG. 10), which implements some or all of a process described herein. In this case, a computer system can process a copy of program code that implements some or all of a process described herein to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of program code that implements some or all of a process described herein, which includes a computer system receiving the set of data signals described herein, and translating the set of data signals into a copy of the computer program fixed in at least one computer-readable medium. In either case, the set of data signals can be transmitted/received using any type of communications link.

In still another embodiment, the invention provides a method of generating a system for analyzing characteristics of material samples. In this case, a computer system, such as computer system 802 (FIG. 10), can be obtained (e.g., created, maintained, made available, etc.) and one or more components for performing a process described herein can be obtained (e.g., created, purchased, used, modified, etc.) and deployed to the computer system. To this extent, the deployment can comprise one or more of: (1) installing program code on a computing device; (2) adding one or more computing and/or I/O devices to the computer system; (3) incorporating and/or modifying the computer system to enable it to perform a process described herein; and/or the like.

It is understood that aspects of the invention can be implemented as part of a business method that performs a process described herein on a subscription, advertising, and/or fee basis. That is, a service provider could offer to analyze characteristics of material samples as described herein. In this case, the service provider can manage (e.g., create, maintain, support, etc.) a computer system, such as computer system 802 (FIG. 10), that performs a process described herein for one or more customers. In return, the service provider can receive payment from the customer(s) under a subscription and/or fee agreement, receive payment from the sale of advertising to one or more third parties, and/or the like.

Turning to FIG. 15, a schematic three-dimensional perspective view of a portion of THz spectrometer 100 is shown according to an embodiment. In this embodiment, a linear optical delay stage 500 includes a retro-reflector 522 which is adjustable via a fine adjustment screw 510 which is connected to an adjustable base 530. Manipulation of fine adjustment screw 510 adjusts a position of retro-reflector 522 and thereby adjusts operation of THz spectrometer 100. In one embodiment, fine adjustment screw 510 may be automatically adjusted via computing device 204. In another embodiment, fine adjustment screw 510 may be manually adjusted by a technician.

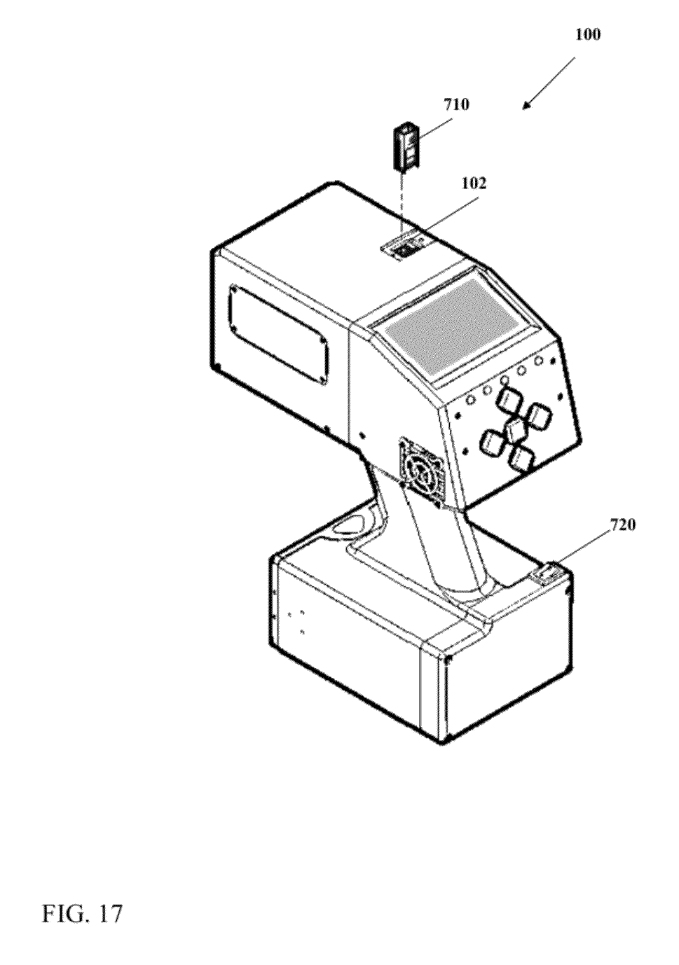

Turning to FIG. 16, a schematic three-dimensional perspective view of a portion of THz spectrometer 100 is shown according to an embodiment. In this embodiment, cover 103 is in a closed position (e.g., covering sample chamber 102) and THz spectrometer 100 is positioned proximate a material sample 700. During operation, a THz radiation pulse 702 may emit from THz lens aperture 109 (shown in FIG. 1) to interact with and/or reflect back to THz spectrometer 100. Portions of THz radiation pulse 702 which reflect back to THz spectrometer 100 may be analyzed to determine a characteristic of sample 700 as discussed herein. In another embodiment, shown in FIG. 17, THz spectrometer 100 may be configured to slidingly receive/connect to a sample vial 710 in sample chamber 102 and expose a portion of material sample 700 contained in sample vial 710 to a THz radiation pulse. During operation, a portion of material sample 700 may be disposed in sample vial 710 for insertion in and analysis by THz spectrometer 100 as discussed herein. Sample vial 710 may be configured to locate the material sample within sample chamber 102 in a path of the THz radiation.

As will be appreciated by one skilled in the art, the system described herein may be embodied as a system(s), method(s), operator display (s) or computer program product(s), e.g., as part of a spectrometer system, a THz spectrometer system, a THz spectrometer, etc. Accordingly, embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module,” “network” or “system.” Furthermore, the present invention may take the form of a computer program product embodied in any tangible medium of expression having computer-usable program code embodied in the medium.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The portable THz spectrometer of the present disclosure is not limited to any one spectrometer, laser source, meter or other system, and may be used with other sensor systems now known or later developed. Additionally, the system of the present invention may be used with other systems not described herein that may benefit from the mobility and data analysis provided by the portable THz spectrometer described herein.

As discussed herein, various systems and components are described as “obtaining” and/or “transferring” data (e.g., analysis data, waveform data, etc.). It is understood that the corresponding data can be obtained using any solution. For example, the corresponding system/component can generate and/or be used to generate the data, retrieve the data from one or more data stores or sensors (e.g., a database), receive the data from another system/component, and/or the like. When the data is not generated by the particular system/component, it is understood that another system/component can be implemented apart from the system/component shown, which generates the data and provides it to the system/component and/or stores the data for access by the system/component.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A spectrometry system comprising:
a portable housing including:
a portable power source;
a laser source connected to the portable power source;
a terahertz (THz) emitter located within the portable housing and optically connected to the laser source via an optical array including a rotary delay stage, the THz emitter configured to emit THz radiation directed to interact with a material sample;
a detector optically connected to the optical array and configured to obtain waveform data from the interaction between the THz radiation and the material sample; and
a computing device communicatively connected to the detector and configured to process the waveform data to determine a characteristic of the material sample.

2. The spectrometry system of claim 1, further comprising a user interface communicatively connected to the computing device, the user interface configured to display the characteristic of the material sample.

3. The spectrometry system of claim 1, wherein the computing device is further configured to:
align a plurality of distinct sample waveforms in the waveform data; and
combine the aligned sample waveforms.

4. The spectrometry system of claim 3, wherein the computing device is further configured to:
generate a set of spectrum data based on the combined and aligned sample waveforms; and
compare the set of spectrum data with a set of authenticated spectrum data to determine the characteristic of the material sample.

5. The spectrometry system of claim 1, wherein the detector includes at least one of an electro-optic (EO) crystal or a photoconductive antenna for obtaining the waveform data.

6. The spectrometry system of claim 1, wherein the laser source is optically coupled to the portable housing, the laser source located external to the portable housing.

7. The spectrometry system of claim 1, wherein the power source is electrically coupled to the portable housing, the power source located external to the portable housing.

8. The spectrometry system of claim 1, further comprising a sample vial slidingly connected to a sample chamber defined within the portable housing, the sample vial configured to locate the material sample within the sample chamber in a path of the THz radiation.

9. The spectrometry system of claim 1, further comprising a lens aperture defined by the portable housing, the lens aperture configured to enable a beam of THz radiation to interact with the material sample while located external to the portable housing.

10. The spectrometry system of claim 1, wherein the THz emitter is interchangeable.

11. The spectrometry system of claim 1, wherein a THz signal obtained by the detector is modulated via manipulation of the rotary delay stage.

12. A program product stored on a computer readable storage medium for determining a characteristic of a material sample, the computer readable storage medium comprising program code for causing a computer system to:
obtain waveform data captured by a detector, the waveform data corresponding to an interaction between the material sample and a terahertz (THz) radiation beam and including a plurality of distinct sample waveforms;
align the plurality of distinct sample waveforms relative one another;
combine the aligned sample waveforms;
process the combined and aligned sample waveforms to generate a set of spectrum data; and
compare the set of spectrum data to a set of authenticated spectrum data to determine the characteristic of the material sample.

13. The program product of claim 12, wherein each distinct sample waveform is obtained at a frequency of greater than about 100 hertz.

14. The program product of claim 12, wherein the aligning the plurality of distinct sample waveforms includes at least one of: aligning each sample waveform based on a peak magnitude of each respective sample waveform; aligning each sample waveform based on a midpoint of a threshold peak value for each sample waveform; or aligning each sample waveform based on a correlation of each sample waveform with an ideal waveform.

15. The program product of claim 12, further comprising program code for causing the computer system to:
determine a time constant (TC) for the waveform data based on at least one of: a variation in the sample waveform; or a variation in a distance from the material sample.

16. The program product of claim 12, further comprising program code for causing the computer system to:
display a result of the material sample characteristic determination on a user interface, the result including at least one of: a confidence level of the determination; or a histogram of the determination.

17. The program product of claim 12, wherein the processing the combined and aligned sample waveforms to generate a set of spectrum data includes calculating a Fourier transform of the combined and aligned sample waveforms.

18. A system comprising:
at least one computing device configured to determine a characteristic of a material sample by performing a method including:
obtaining waveform data captured by a detector, the waveform data corresponding to an interaction between the material sample and a terahertz (THz) radiation beam and including a plurality of distinct sample waveforms;
aligning the plurality of distinct sample waveforms relative one another;
combining the aligned sample waveforms;
processing the combined and aligned sample waveforms to generate a set of spectrum data; and
comparing the set of spectrum data to a set of authenticated spectrum data to determine the characteristic of the material sample.

19. The system of claim 18, further comprising a user interface communicatively connected to the at least one computing device, the user interface configured to display the characteristic of the material sample and at least one of: a confidence level of the determination; or a histogram of the determination.

20. The system of claim 18, wherein the obtaining a set of waveform data for the material sample includes determining a time constant (TC) for the waveform data based on at least one of: a variation in the sample waveform; or a variation in a distance from the material sample.
